(19) United States
(12) Patent Application Publication
(10) Pub. No.: US 2004/0002871 A1
(43) Pub. Date: Jan. 1, 2004

(54) Integrated property database and search engine

(76) Inventor: Nicholas L. Geranio, Calabasas, CA (US)

Correspondence Address: LAW OFFICES OF ERIC KARICH, 2807 ST. MARK DR., MANSFIELD, TX, 76063, US

(21) Appl. No.: 10/608,289

(22) Filed: Jun. 27, 2003

Related U.S. Application Data
(60) Provisional application No. 60/392,701, filed on Jun. 27, 2002.

(51) Int. Cl. G06F 17/60

(52) U.S. Cl. 705/1

(57) ABSTRACT

An integrated property database and search engine for matching properties with buyers has a computer that includes a master database and a search engine. The master database includes a property for sale database and a buyer's database. The property for sale database includes a property identification, a property location, and a property price. The buyers database includes a buyer's identification, a location of interest, and an offer price. A request is sent to the buyer for ascertaining information to be contained in the buyers database. An inquiry is sent to ascertain information to be contained in the property for sale database. A search engine is used to identify properties in the property for sale database that have a property location within the location of interest for a buyer, and have a property price that is equal to or lower than the offer price.

### CROSS-REFERENCE TO RELATED APPLICATIONS

This application for a utility patent claims the benefit of U.S. Provisional Application No. 60/392,701, filed Jun. 27, 2002.

### STATEMENT REGARDING FEDERALLY SPONSORED RESEARCH

Not Applicable

### BACKGROUND OF THE INVENTION

1. Field of the Invention

This invention relates generally to databases, and more particularly to an integrated property database and search engine for matching buyers and sellers of real estate.

2. Description of Related Art

When a buyer is typically looking for a piece of real estate, he typically searches a central computer system generally referred to as a “multiple listing service.” This computer listing enables the search for properties that have been offered for sale, their location, and their current asking price. However, the search of the stored information is typically dependent on the operator's intricate knowledge of the local area, and is capable of only searching for properties that have been listed.

While the multiple listing service is of great value, it often does not contain properties that may be for sale but have not yet been listed. The multiple listing service also does not include information about properties that are not currently for sale, but may be available for sale if the current owner is presented with an attractive price.

Other real estate search systems include the following:

Tornetta, U.S. Pat. No. 5,032,989, teaches a method for locating available real estate properties for sale, lease or rental using a database of available properties at a central location and remote stations which use a graphic interface to select desired regions on a map of the areas of interest. The user begins with a region where they are interested in acquiring property and select an inner area within this region by using a pointing device such as a mouse to designate boundaries on a map displayed on screen. This is then zoomed in on and a second area is selected within the zoomed region. The second area is then cross-referenced with the database of available properties whose approximate locations are then pictorially displayed on screen. Information about the properties can then be obtained in textual form.

Apgar, I V, U.S. Pat. No. 5,680,305, teaches a method of formulating objective evaluations of a business entity's real estate. Information is processed to determine indicators of amount, price, area, grade, and risk; and those indicators are combined to provide a total score. The system includes a database for storing a variety of data, such as utilization measures and business information, and data corresponding to businesses which are similar to the business entity. Process actuators process the information to derive the several indicators, the score, and other measures, which is printed or displayed for customers and/or the business entity. Preferably, a report is generated which details information including the score to provide a well-rounded picture of a particular real estate situation.

The prior art teaches a multiple listing service of properties that have been listed for sale. However, the prior art does not teach a system and method for searching properties that have not been listed. The present invention fulfills these needs and provides further related advantages as described in the following summary.

### SUMMARY OF THE INVENTION

The present invention teaches certain benefits in construction and use which give rise to the objectives described below.

The present invention provides an integrated property database and search engine for matching properties with buyers. The integrated property database and search engine is executed on a computer having a master database and a search means. The master database includes a property for sale database and a buyer's database. The property for sale database has a plurality of property definition fields that include a property identification, a property location, and a property price. The buyers database has a plurality of buyers definition fields that include a buyer's identification, a location of interest, and an offer price. The integrated property database and search engine further includes a means for generating and transmitting a plurality of requests to the buyers for ascertaining information to be contained in the buyers database; a means for generating and transmitting a plurality of inquiries to the properties for ascertaining information to be contained in the property for sale database; a means for incorporating information from the plurality of requests into the buyers database, and for incorporating information from the plurality of inquiries into the property for sale database; and a search means for identifying properties in the property for sale database that have a property location within the location of interest for a buyer, and have a property price that is equal to or lower than the offer price.

A primary objective of the present invention is to provide an integrated property database and search engine having advantages not taught by the prior art.

Another objective is to provide an integrated property database and search engine that is capable of searching for real estate properties that have not yet been listed for sale.

Another objective is to provide an integrated property database and search engine that is capable of searching for real estate transactions even when the property owner does not know that he or she may be interested in selling the property.

A further objective is to provide an integrated property database and search engine that also finds investors that may be interested in financing a real estate transaction.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a block diagram of a preferred embodiment of the present invention, illustrating a master database and a search means operably installed on a computer;

FIG. 2A is a block diagram of a request being transmitted from a buyer to the master database;

FIG. 2B is a block diagram of one embodiment of the request;

FIG. 3A is a is a block diagram of an inquiry being transmitted from the master database to a seller, and of a response being transmitted back;

FIG. 3B is a block diagram of one embodiment of the inquiry;

FIG. 4 is a block diagram of the computer being used to transmit a purchase opportunity letter to the buyer, a sales opportunity letter to the seller, and an investment opportunity letter to an investor; and

FIG. 5 is a block diagram of the buyer, the seller, and the investor each transmitting an acceptance to the computer.

### DETAILED DESCRIPTION OF THE INVENTION

The above described drawing figures illustrate the invention, an integrated property database and search engine 10 for matching buyers 12, sellers 14, and investors 16 interested in executing real estate transactions.

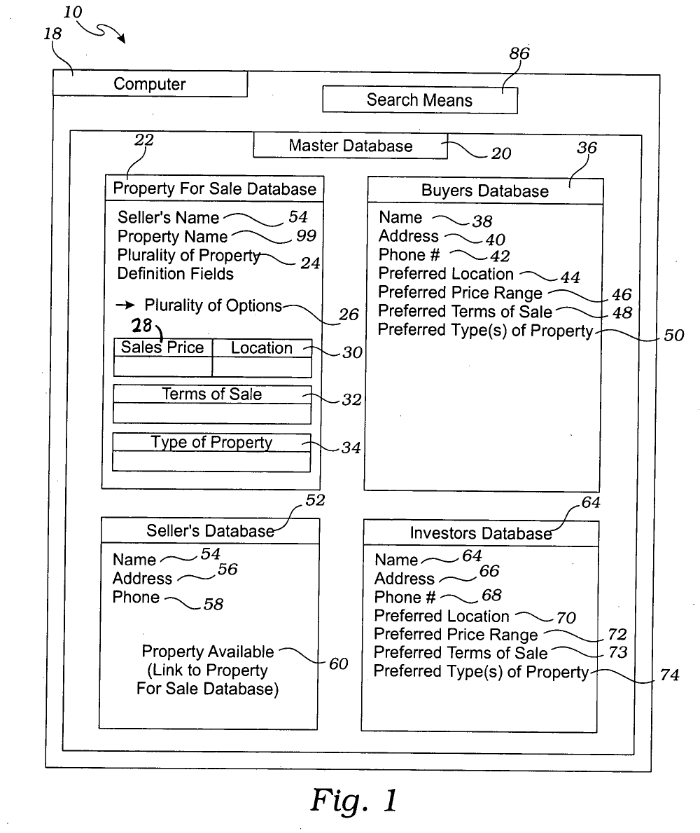

As shown in FIG. 1, the integrated property database and search engine 10 is executed on a computer 18 that includes a master database 20 and a search means 86. The master database 20 includes a property for sale database 22 and may also include a buyers 12 database, a sellers 14 database, and an investors 16 database. The property for sale database 22 has a plurality of property definition fields 24, each of the property definition fields having a plurality of options 26. The plurality of property definition fields 24 may include a sales price 28, a location 30, and terms of the sale. The plurality of options 26 for the sales price 28 could include any dollar amount, or could be rounded to the nearest 10 or 100 dollars. The plurality of options 26 for the location 30 could be by state, region, county, area code, or by custom region, or any other scheme that suits the needs of the buyers 12 and sellers 14.

Other features that are likely to be included in the plurality of property definition fields 24 include terms of the sale 32 and type of property 34. The terms of the sale 32 may include any of the various terms that those skilled in the art are likely to bargain for or against. The plurality of options 26 may include who pays the various costs, fees, taxes, and other amounts; the length of the escrow period; the amount of the deposit; and any other terms that are well known in the art. The type of property 34 may include single family detached housing, condos, townhouses, apartments, hotels, commercial space, warehouse space, unimproved land, farmland with or without irrigation, or any other type of property.

The property for sale database 22 may also include the seller's name 54 (or some other form of link with the sellers database 52), and it may include a property name 99 for purposes of identification of the property. The property name 99 may include all or a portion of the address or location of the property, or it may be another name, or it may be a unique identifier number that is assigned to the property.

Each of the buyers, sellers, and investors databases 36, 52, and 62 include contact and other information about the person or entity, including name, address, phone number, and information about the type of transaction in which they are interested. For example, the buyers 12 database may include a name 38, address 40, phone number 42, preferred location 44, preferred price range 46, preferred terms of sale 32, and preferred type(s) of property 50 that the buyer 12 is interested in purchasing.

The sellers database 52 may include a name 54, address 56, phone number 58, and any other contact information or other information that may be of use. The sellers database 52 also includes a list of property available 60 that the seller 14 is interested in selling, with an appropriate link to the property for sale database 22.

The investor database 62 may include a name 64, address 66, phone number 68, preferred location 70, preferred price range 72, preferred type(s) of property 74, and other information of interest.

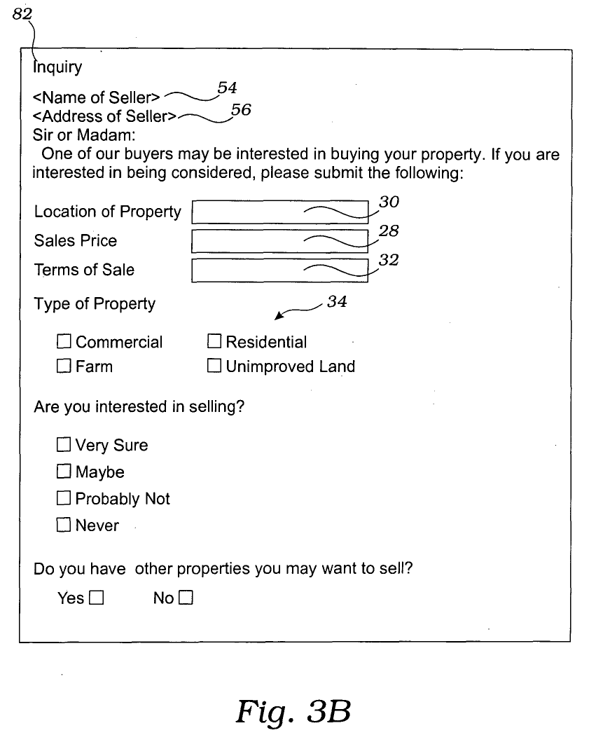

Other information about the buyer 12, seller 14, or investor 16 may also be included. An example of additional information may include information about past transactions to which that party has participated, and potentially any positive or negative feedback that other parties have reported about that party. A great deal of information can be collecting regarding buyers 12, sellers 14, investors 16, and property for sale are available from property listing sources and other online information accessible through a computer network 88 (shown in FIG. 4) such as the world wide web. This information can be stored data in the master database 20.

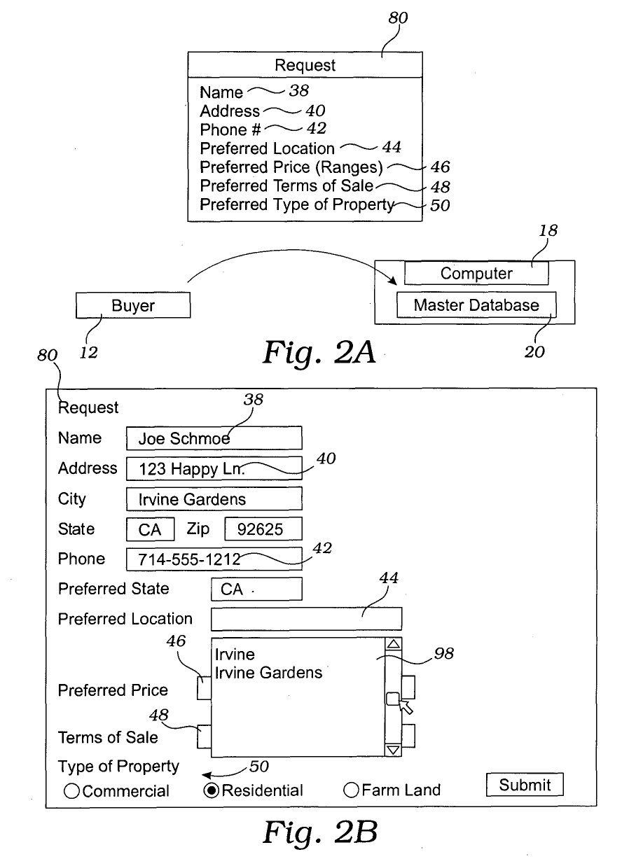

The integrated property database and search engine 10 further includes a means for generating and transmitting a plurality of requests 80 to the buyers 12 for ascertaining information to be contained in the buyers database 36. As shown in FIG. 2A, in one embodiment the request 80 is a form that is adapted to be completed by the buyer 12 and submitted for entry into the computer 18.

The request 80, an example of which is shown in FIG. 2B, may have been printed and mailed or faxed, or it may be a form that is electronically generated and emailed to the buyer 12, or the buyer 12 may have accessed the request 80 via the computer network 88 (shown in FIG. 4). In another embodiment, the request 80 may be completed by a real estate specialist (not shown) during a phone consultation with the buyer 12. The request 80 enables the buyer 12 to select one of the plurality of options 26 for each of the plurality of property definition fields 24. In an electronic format, the request 80 could include a drop down menu 98 of options; and in paper format, the request 80 may include pre-printed responses that the buyer 12 circles or checks; or the request 80 may be a paper that includes blanks that are filled in by hand.

The integrated property database and search engine 10 further includes a means for incorporating information from the plurality of requests 80 into the buyers database. Foe example, the buyer 12 may mail, fax, email, or otherwise transmit the request 80 to an office associated with the computer 18 for data entry or direct integration into the master database 20. In another embodiment, the request 80 may be completed over the phone, when the seller 14 is speaking with a property specialist, who can take the necessary information over the phone and input the information directly into the master database 20. Those skilled in the art can devise many methods of scanning or otherwise entering the data into the computer 18.

This aspect of the invention is discussed in greater detail below. The integrated property database and search engine 10 further includes a means for generating and transmitting a plurality of inquiries 82 to the properties (or to the owners of the properties, or any other appropriate entity) for ascertaining information to be contained in the property for sale database 22.

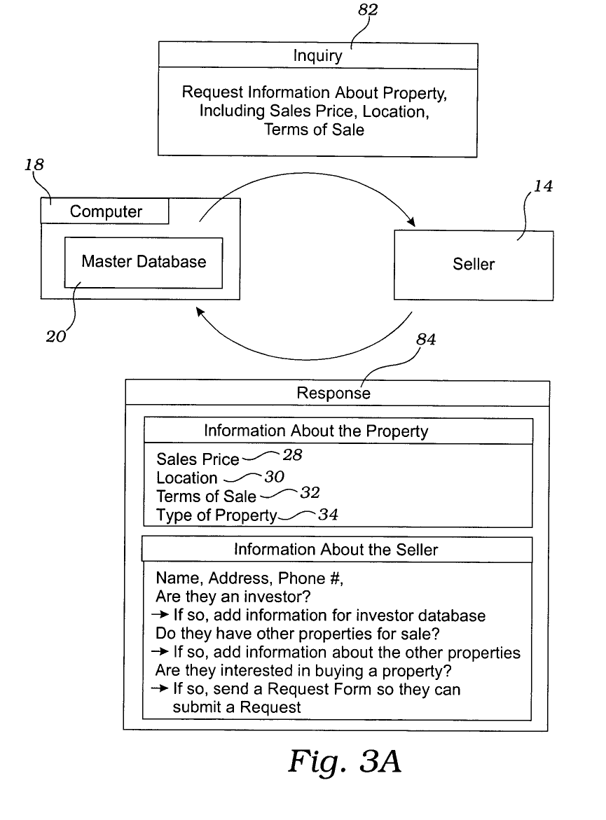

As shown in FIG. 3A, in one embodiment this means for receiving is an inquiry 82 that is transmitted to each of the sellers 14 or other persons who have control over a piece of property that may be offered for sale. The inquiry 82 requests that the person provide all of the information that should be included in the sellers database 52, including the sales price 28, the location 30 of the property, the terms of the sale 32, and the type of property 34. One embodiment of the inquiry 82 is shown in FIG. 3B. The inquiry 82 may be a letter that is mailed to the listed address of the seller 14 (or, if the seller is not known, to the address of the property). As discussed above, technology allows many methods of providing and transmitting the inquiry 82, including telephone calls, emails, faxes, or any other forms of communication that can provide the necessary information, and these alternatives should be considered within the scope of the claimed invention. The inquiry 82 is useful not only to ascertain the sales price 28 of the property, but to also confirm that any data that was previously collected is correct and current, for future mailings.

The inquiry 82 may also request 80 that the seller 14 identify whether he or she is also a buyer of real estate and/or is interested in investing in real estate. If the seller 14 is also a buyer 12 and/or investors 16, the seller 14 is requested 80 to provide at least some of the information required by the buyers and investors databases 36 and 62. In the alternative, the seller 14 may be simply asked to check a box and later follow up may be used to ascertain the details of the seller's interests in buying and investing.

As discussed above, the integrated property database and search engine 10 includes a means for incorporating information from the requests 80 into the buyers database 36, and for incorporating information from the inquiries 82 into the property for sale database 22. This can include directly entering data into the master database 20, scanning the data in using technology known in the art, or having the interested parties enter the information directly over the computer network 88.

As shown in FIGS. 1 and 4, the integrated property database and search engine 10 includes a search means 86 for identifying properties in the property for sale database 22 that have a location 30 within the preferred location 44 of the buyer 12, have a sales price 28 that is equal to or lower than the preferred price range 46, and the type of property 34 is the same as the preferred type of property 50 specified by the buyer 12. The search means 86 functions to match buyers 12, sellers 14, and investors 16 based on the information in the master database 20, preferably using a search algorithm (not shown) running on the computer 18. Recursive search routines, or other suitable algorithms, are known to those skilled in the art and are therefore not described in greater detail herein.

As shown in FIG. 4, the computer 18 is used to generate a purchase opportunity letter 90, a sale opportunity letter, and an investment opportunity letter 94. The purchase opportunity letter 90 is transmitted, by mail, email, phone, or other method of communication, to the buyer 12. The purchase opportunity letter 90 describes the property, the sales price 28, the terms of the sale, and any other information of interest. The sale opportunity letter is transmitted to the seller 14, and the investment opportunity letter 94 is transmitted to the investor 16.

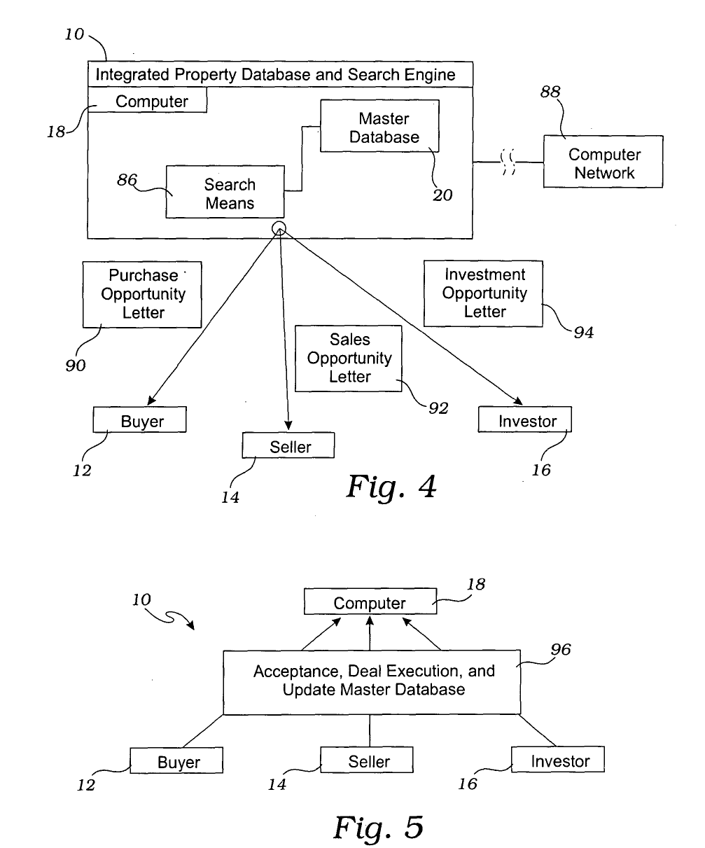

As shown in FIG. 5, the buyer 12, seller 14, and/or investor 16 may transmit an acceptance 96 indicating that they would like to proceed with the deal. The details of the acceptance 96 may vary depending upon the specific embodiment of the system used. The acceptance 96 could be a general, non-binding invitation to have the parties meet and form a legally binding agreement using an escrow arrangement known in the art. If there are other terms to be negotiated, they are negotiated by the appropriate professionals, and an agreement could be executed. The final execution of contracts, the escrow period, and other details of the sale are well known to those skilled in the art.

In the alternative, the computer 18 could be used to form a legally binding agreement using electronic signatures and form papers or electronic forms to complete all of the legally required terms of the deal.

Following are some sample questions that may be asked of the seller 14;

What is your name?

What is your Phone Number?

What is your address?

What is the property address you are interested in selling?

Why are you selling?

How many units is the property?

What is the Square footage of the property?

Who built the property?

What is the condition of the property?

Roof

Foundation

Floor

Carpets

Bathrooms

Paint: interior, exterior

What is the current rent of the property?

Is there rent control?

How much do you want for the property?

What terms of that you are willing to sell?

Will you carry back a second for 10%, 20%, 30%?

Will you carry the first for the whole amount 70%, 80% 90%?

The seller 14 may also be a buyer 12, since he or she may be selling a property that may need to be replaced. A follow up questionnaire may seek additional information:

Are you interested in purchasing property in the near future?

What type of property are you looking for?

How much are you looking to spend?

Where are you looking to buy?

The seller 14 may also want to be an investor 16:

Are you interested in investing in real estate?

What terms are you looking for?

In what type of property are you interested in investing?

How much are you looking to invest?

Where are you looking to invest?

The search means 86 will immediately: locate a buyer 12 for the property; find a property for the seller 14 to buy; and/or match financing with a potential deal. The information will be immediately dispatched to the buyer 12/seller 14/investor 16 via mail, fax, email, and/or by phone (or other suitable means) to arrange signatures on a listing agreement, a sales agreement, and an investment agreement. A broker has the buyer 12 sign a non circumvention agreement and the buyer 12 can view the property and the specific terms of the deal. If agreeable, the buyer 12 can submit an offer on the property and proceed with the deal.

The invention includes a method for matching properties with buyers 12. The method includes first transmitting the plurality of requests 80, described above, to the buyers 12 for ascertaining a preferred location 44 and a preferred price range 46 for each of the buyers 12. At least some of the plurality of requests 80 are received once they have been completed, and the information is inputted into a buyers database 36. As described above, the request 80 could be a web page that enables the data to be inputted directly into the buyer database 36 by the buyer 12. In another embodiment, the request 80 is a paper document that is mailed, completed manually, mailed back to a central processing area (not shown), where the information is inputted into the computer 18. Additional methods are described above, and should be considered within the scope of the present invention.

Similar to the method described above, the plurality of inquiries 82 are transmitted for ascertaining the sales price 28 and the location 30 of the properties. At least some of the plurality of inquiries 82 are received once they have been completed, and the information is used to create a property for sale database 22. The search means 86 is then used to identify at least one property in the property for sale database 22 that has a location 30 that matches the preferred location 44 of at least one of the buyers 12, and that has a sales price 28 equal to or less than the preferred price range 46 of the at least one buyer 12.

Once a potential transaction has been identified, the integrated property database and search engine 10 further functions to discover an investor from the inventors database 64 who may be interested in financing the transaction. The sales price 28, location 30, and the type of property 34 (among potentially other terms) are compared to the preferred price range 72, the preferred location 70, and the preferred type of property 74 to determine which investor(s) may be interested in financing the transaction. As shown in FIG. 4, and as described above, an investment opportunity letter 92 is mailed (or otherwise transmitted) to the investor(s) 16. If they are interested, the investor 16 can transmit an acceptance 86.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An integrated property database and search engine for matching properties with buyers, the integrated property database and search engine comprising:
A computer having a master database that includes a property for sale database and a buyer's database;
the property for sale database having a plurality of property definition fields, the property definition fields including a property identification, a property location, and a property price;
the buyers database having a plurality of buyers definition fields, the plurality of buyers definition fields including a buyer's identification, a location of interest, and an offer price;
a means for generating and transmitting a plurality of requests to the buyers for ascertaining information to be contained in the buyers database;
a means for generating and transmitting a plurality of inquiries to the properties for ascertaining information to be contained in the property for sale database;
a means for incorporating information from the plurality of requests into the buyers database, and for incorporating information from the plurality of inquiries into the property for sale database; and
a search means for identifying properties in the property for sale database that have a property location within the location of interest for a buyer, and have a property price that is equal to or lower than the offer price.

2. The integrated property database and search engine of claim 1 wherein the search means is a recursive search algorithm.

3. The integrated property database and search engine of claim 1 wherein the means for incorporating includes a computer network and software for importing data from the plurality of requests and the plurality of inquiries into the master database.

4. A method for matching properties with buyers, the method comprising the steps of:
transmitting a plurality of requests to the buyers for ascertaining a preferred location and a preferred price range for each of the buyers;
receiving at least some of the plurality of requests once they have been completed;
creating a buyers database from the plurality of requests that are completed;
transmitting a plurality of inquiries for ascertaining a sales price and a location of the properties;
receiving at least some of the plurality of inquiries once they have been completed;
creating a property for sale database from the plurality of inquiries; and
identifying at least one property in the properties for sales database that has a location that matches the preferred location of at least one of the buyers, and that has a sales price equal to or less than the preferred price range of the at least one buyer.

5. The method of claim 4 further comprising the steps of:
creating an investors database having a preferred location, a preferred price range, and a preferred type of property for each of a plurality of investors; and
comparing the sales price, location, and type of property in the property for sale database with the preferred location, preferred price range, and the preferred type of property of the investors database to find investors that may be interested in financing the sale of the property.

6. The method of claim 5 further comprising the step of:
transmitting an investment opportunity letter to the investor.

7. The method of claim 6 further comprising the step of:
receiving an acceptance from the investor.
